(19) United States
(12) Patent Application Publication
(10) Pub. No.: US 2020/0152085 A1
(43) Pub. Date: May 14, 2020

(54) Geometric Pattern Splicing Device

(71) Applicant: Shaofei Hu, Beijing (CN)

(72) Inventor: Shaofei Hu, Beijing (CN)

(21) Appl. No.: 16/269,322

(22) Filed: Feb. 6, 2019

(30) Foreign Application Priority Data
Nov. 12, 2018 (CN) 201811337661.8

(51) Int. Cl. G09B 23/00; G06T 3/40; G06T 11/60

(52) U.S. Cl. CPC G09B 23/00; G06T 11/60; G06T 3/4038

(57) ABSTRACT

The present invention relates to the field of assisting teaching technology, and in particular, to a geometric pattern splicing device, which comprises m sets of splicing units, wherein each set of splicing units contains n types of splicing plates, and the splicing plate is made of a pasteable material or a magnetic structure for pasting or adsorbing the splicing plate on a carrier; the splicing plate is an isosceles triangle, the same set of splicing plates are similar triangles, the apex angles of the splicing plates are unequal in any two sets, and the bottom lengths of the ath type of splicing plates are equal; in the same set of splicing units, when the apex angle of the splicing plate is equal to 60°.

### CROSS REFERENCE TO RELATED APPLICATION

This application takes priority from and claims the benefit of Chinese Patent Application Serial No. 201811337661.8 filed on Nov. 12, 2018, the contents of which are herein incorporated by reference.

### BACKGROUND OF THE INVENTION

### Field of the Invention

The present application relates to a geometric pattern splicing device.

### Description of the Related Art

Hands-on experiments and self-exploration are important ways to learn mathematics. At present, the teaching of “Pattern and Geometry” is mainly based on teacher presentation and explanation. Due to limited classroom time, fewer links that each student can have hands-on operation or less experience time is not conducive to self-exploration and independent thinking of students. In the spare time, the thinking ability of students trained through geometric pattern splicing teaching tools is an important link of learning.

In terms of product design, the geometric pattern splicing toy products on the market are almost all composed of the basic geometric splicing plates such as regular triangles, squares and regular hexagons, diamonds, trapezoids, etc. derived therefrom. The geometric pattern splicing plates provided by most of the products have not changed in structure. Although the individual products have changed in structure, this is only a simple repetition of a single shape, and is not associated with other different types of geometric pattern splicing plates.

In addition, the area of the geometric splicing plate changes, only the type of splicing plates such as an isosceles right triangle has two or three different sizes, and is not scaled separately for other different types of geometric splicing plates, so that there are regular changes in the area, which cannot lead the user to further have a deep exploratory thinking about the nature of geometric patterns.

As far as the age distribution of product users is concerned, the existing products are mainly designed for children of lower ages, and can play the role of preliminarily understanding simple geometric patterns for users, but are not suitable for people of middle and high ages.

From the reference pattern provided by the product, it can only play the role of preliminarily understanding simple geometric patterns for students, and cannot lead students to think about the nature of different geometric patterns. There are few patterns for reference, and the number of pattern blocks contained in a single set of products is small, the shape is single, and the pattern structure after being spliced is simple, which cannot meet the needs of students to complete their own unique creative works. Moreover, after the pattern or shape is spliced, it cannot be better fixed in one place, or it needs to be removed to splice another one, and the creative works completed by the children cannot be preserved.

Therefore, how to solve the problem that the existing pattern splicing teaching tools are small in type and number, single in shape, simple in splicing structure, and inconvenient in splicing and preservation are key technical problems to be solved by those skilled in the art.

### SUMMARY OF THE INVENTION

In order to overcome the problems in the related art at least to some extent, the purpose of the present application is to provide a geometric splicing device capable of solving the problem that the existing pattern splicing teaching tools are small in type and number, single in shape, and simple in splicing structure.

This application provides a completely new geometric pattern splicing device:

1. The structures of the triangular splicing plates evolved based on a variety of regular polygons with the same side length are: 120°, 108°, 90°, 60°, 45°, and 36°, respectively.

2. Different types of splicing plates are scaled up and down, respectively, so that they have regular changes in area.

In the overall design, the connection between the triangle and the polygon is highlighted, so that different types of splicing plates establish a certain relationship with each other.

The present application provides a geometric pattern splicing device for assisting teaching and for playing games, comprising: m sets of splicing units, wherein each set of splicing units contains n types of splicing plates, and the splicing plate is made of a pasteable material or a magnetic structure so that the splicing plate is capable of being pasted or adsorbed on a carrier; where m is a positive integer greater than or equal to 2, and n is a positive integer greater than or equal to 3;

the splicing plate is an isosceles triangle, the same set of splicing plates are similar triangles, the apex angles of the splicing plates are unequal in any two sets, and the bottom lengths of the ath type of splicing plates are equal; in the same set of splicing units, when the apex angle of the splicing plate is equal to 60°, the area of the kth type of splicing plates is equal to three times the area of the k−1th type of splicing plates, and when the apex angle of the splicing plate is greater than or less than 60°, the waist length of the kth type of splicing plates is equal to the bottom length of the k−1th type of splicing plates, where a∈{1, 2, . . . , n}, k∈{2, 3, . . . , n}.

Preferably, the geometric splicing device further comprises a plurality of regular polygonal plates, each of which has a side length equal to the bottom length of the ath type of splicing plates.

Preferably, the geometric splicing device further comprises a plurality of diamond plates having a side length equal to the bottom length of the ath type of splicing plates.

Preferably, the splicing plate is made of paper, and the splicing plate is fixed on the carrier by an adhesive applied on one side.

Preferably, the geometric splicing device further comprises a carrier for carrying and splicing the splicing plate, wherein the splicing plate is provided with a magnetic structure comprising a first magnetic member on the splicing plate and a second magnetic member on the carrier, and the first magnetic member and the second magnetic members are attracted to each other.

Preferably, the first magnetic member is provided as a magnet and is located inside the splicing plate, and the second magnetic member is an iron layer provided on the carrier.

Preferably, one side of each set of splicing plates is coated with a different color, and the color depth of the kth type of splicing plates in the same set is smaller than the color depth of the k−1th type of splicing plates.

Preferably, there are provided with 2-6 sets of splicing units, and the apex angles of each set of splicing plates 1 are 120°, 108°, 90°, 60°, 45°, and 36°, respectively.

Preferably, the color of each set of splicing plates is purple, orange, red, yellow, green, and blue, respectively.

Preferably, the bottom length of the ath type of splicing plates is set to 45-55 mm.

The technical solutions provided by the present application may comprise the following beneficial effects.

The geometric splicing device is used for assisting teaching, and can make up for the lack or deficiency of the links between “hands-on operation” and “self-exploration” when students are learning the knowledge of “pattern and geometry”. The geometric splicing device is designed for children over the age of three and adults, and is designed based on the content of “pattern and geometry” in mathematics; a visual image is used as a carrier, and a variety of patterns are used to stimulate the user's interest in geometric patterns. The splicing plates are large in type and number, which can produce an ever-changing pattern combination effect and can exert the subjectivity and creativity of each person.

The splicing plate can be pasted or adsorbed on the carrier, which is convenient for splicing and storage. Moreover, the type and number of splicing plates are large, and the spliced pattern structure is complex and varied but regular. There is a certain splicing relationship between the two types of splicing plates, which is conducive to the production of an ever-changing pattern combination effect.

The used geometric blocks can produce an ever-changing pattern combination effect, which can exert the subjectivity and creativity of each person. Since the geometric splicing device can be a material that can be pasted or adsorbed, it is possible to not only complete the creative works designed by oneself, but also can be preserved.

It should be understood that the above general description and the following detailed description are merely intended to be exemplary and illustrative, but are not intended to limit the present application.

### BRIEF DESCRIPTION OF THE DRAWINGS

The accompanying drawings, which are incorporated in and constitute a part of this specification, illustrate embodiments consistent with the present application and serve to, together with the description, explain the principles of the present application.

In order to more clearly illustrate the embodiments of the present invention or the technical solutions in the prior art, the drawings used in the embodiments or the description of the prior art will be briefly described below. Obviously, the drawings in the following description are merely some embodiments of the present invention, and other drawings can be obtained from these drawings for those skilled in the art without any creative work.

FIG. 1 is a top plan view illustrating a splicing plate and a carrier according to some exemplary embodiments;

FIG. 2 is a top plan view illustrating a regular polygonal splicing plate according to some exemplary embodiments;

FIG. 3 is a schematic diagram illustrating the relationship between various splicing plates according to some exemplary embodiments;

FIG. 4 is a schematic diagram illustrating the splicing of a plurality of splicing plates according to a first exemplary embodiment;

FIG. 5 is a schematic diagram illustrating the splicing of a plurality of splicing plates according to a second exemplary embodiment;

FIG. 6 is a schematic diagram illustrating the splicing of a unit module according to a first exemplary embodiment;

FIG. 7 is a schematic diagram illustrating the splicing of a unit module according to a second exemplary embodiment;

FIG. 8 is a schematic diagram illustrating the splicing of the same set of splicing plates according to a first exemplary embodiment;

FIG. 9 is a schematic diagram illustrating the splicing of the same set of splicing plates according to a second exemplary embodiment;

FIG. 10 is a schematic diagram illustrating the splicing of the same set of splicing plates according to a third exemplary embodiment.

### DETAILED DESCRIPTION OF THE SEVERAL EMBODIMENTS

Exemplary embodiments will be described in detail herein, examples of which are illustrated in the accompanying drawings. When the following description refers to the drawings, the same numbers in different drawings indicate the same or similar elements, unless otherwise indicated. The embodiments described in the following exemplary embodiments do not represent all embodiments consistent with the present application. Rather, they are merely examples of devices or methods consistent with some aspects of the present application.

The embodiment provides a geometric splicing device, which is convenient for splicing and storage. Moreover, the type and number of splicing plates are large, and the spliced pattern structure is varied. There is a certain splicing relationship between the two types of splicing plates, which is conducive to splicing more types of patterns.

In order to make the objects, technical solutions and advantages of the present invention more clear, the technical solutions of the present invention will be described in detail below. It is apparent that the described embodiments are only a part of the embodiments of the present invention, rather than all of the embodiments. All other embodiments obtained by those skilled in the art based on the embodiments of the present invention without any creative work are within the scope of protection of the present invention.

Hereinafter, embodiments will be described with reference to the drawings. Furthermore, the embodiments shown below do not limit the present invention as set forth in the claims. Further, the entire contents of the configurations shown in the following embodiments are not necessarily limited to the solutions of the present invention as set forth in the claims.

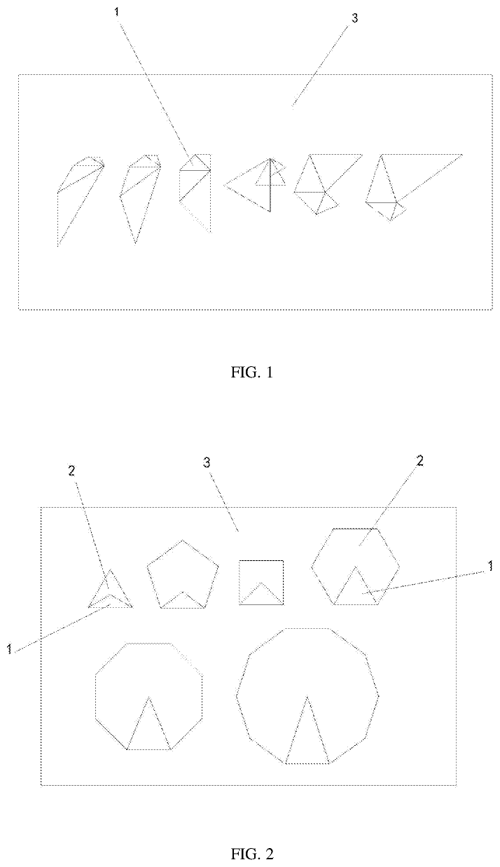

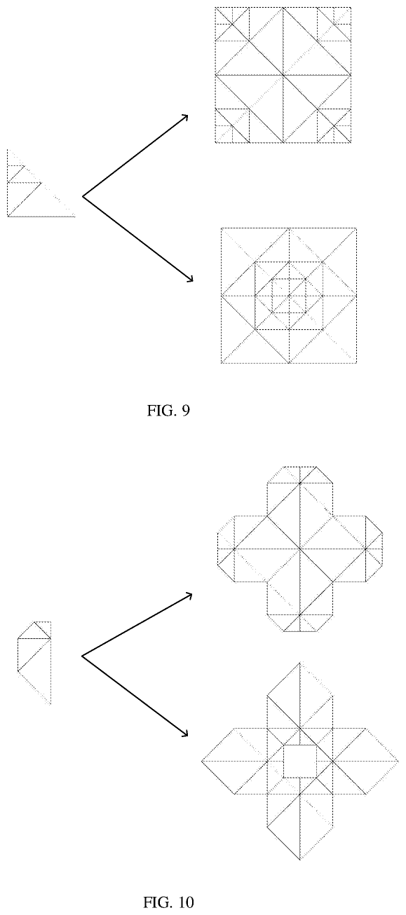

Referring to FIG. 1 to FIG. 10, this embodiment provides a geometric pattern splicing device, comprising: m sets of splicing units, wherein each set of splicing units contains n types of splicing plates 1, that is, the geometric pattern splicing device comprises m*n types of splicing plates 1, and each type of splicing plates 1 may further comprise a plurality of splicing plates 1, where m is a positive integer greater than or equal to 2, and n is a positive integer greater than or equal to 3. In this way, the type and number of splicing plates 1 are larger, which is conducive to splicing a variety of patterns, so that the spliced pattern structure is complex; by hands-on operation of changing patterns, students can understand from specific and special geometric patterns, then understand the abstract and general geometry, explore the inner laws actively and feel the beauty of mathematics.

The splicing plate 1 is made of a pasteable material or a magnetic structure so that the splicing plate 1 is capable of being pasted or adsorbed on a carrier. Herein the carrier is configured to accommodate, support or carry the splicing plate 1 so that the splicing plate 1 can be spliced together to form a complete pattern. The carrier can be a desktop, paper, a pad, a wall, glass, etc., depending on the specific splicing environment. In the splicing process, the splicing plate 1 can be temporarily fixed on the carrier, which facilitates the splicing of the splicing plate 1. During preservation, the position of the splicing plate 1 can be prevented from shifting, and the splicing plate 1 is pasted on the paper. We cannot only complete our own unique creative works, but also gradually understand and master the nature of the planar geometry in the process of making and designing the pattern splicing, which is conducive to the further study of the content of “pattern and geometry”.

It should be noted that the “pasteable material” as used herein is a material that can be pasted to the carrier by a means, and can be paper, plastic, and rubber. For example, one side of the paper splicing plate 1 is coated with adhesive during use to fix the splicing plate 1 and the carrier together; the “magnetic structure” may be an adsorption structure between magnets, or may be an adsorption structure between the magnet and the iron, depending on the specific situation.

The splicing plate 1 is an isosceles triangle, and the same set of the splicing plates 1 are similar triangles. Two triangles in which the three angles are equal and the three sides are proportional to each other are referred to as “similar triangles”, so that in the same set of splicing units, the apex angles of each type of splicing plates 1 are equal, and each type of splicing plates 1 is the same in shape and proportional in size; moreover, the apex angles of the splicing plates 1 are unequal in any two sets, and the bottom lengths of the ath type of splicing plates 1 are equal. For example, when the second type of splicing plates 1 in the first set of splice units can be compared with the second type of splicing plates 1 in the second set of splice units, the bottom lengths of both types of splicing plates 1 are equal; and when the third type of splicing plates 1 in the third set of splice units can be compared with the third type of splicing plates 1 in the fourth set of splice units, the bottom lengths of both types of are equal, which will be not listed in detail any longer. In this way, the difference in sizes of any two sets of splicing plates 1 is not too large, which facilitates the splicing between the sides of the two splicing plates 1, and the shapes of the splicing plates 1 are different, which is conducive to improving the diversity of the shape of the splicing pattern so that the spliced pattern structure is diverse.

In the same set of splicing units, when the apex angle of the splicing plate 1 is equal to 60°, that is, when the splicing plate 1 is a regular triangle, the area of the kth type of splicing plates 1 is equal to three times the area of the k−1th type of splicing plates 1, that is, the side length of the kth type of splicing plates 1 is equal to twice the height of the k−1th type of splicing plates 1; and in the same set of splicing units, when the apex angle of the splicing plate 1 is greater than or less than 60°, the waist length of the kth type of splicing plates 1 is equal to the bottom length of the k−1th type of splicing plates 1. In this way, the splicing plates 1 in the same set of splicing units are similar triangles, and the scaling ratio is fixed, so that the sides of the two adjacent types of splicing plates 1 have the same length, which is conducive to splicing between the sides and improving the diversity of the splicing structure.

It should be noted that a∈{1, 2, . . . , n}, where a is any positive integer ranging from 1 to n, and comprises 1 and n; k∈{2, 3, . . . , n}, where k is any positive integer ranging between 2 and n, and comprises 2 and n.

In this way, the splicing plate 1 can be pasted or adsorbed on the carrier, which is convenient for splicing and storage. Moreover, the type and number of splicing plates are large, and the spliced pattern structure is complex. There is a certain splicing relationship between the two types of splicing plates, which is conducive to splicing more types of patterns; the geometric splicing device is used for assisting teaching, and can make up for the lack or deficiency of the links between “hands-on operation” and “self-exploration” when students are learning the knowledge of “pattern and geometry”. A visual image is used as the carrier, using the varied patterns and beautiful colors to stimulate students' interest in geometric patterns.

In this embodiment, the geometric splicing device further comprises a plurality of regular polygonal plates 2, each of which has a side length equal to the bottom length of the ath type of splicing plates 1, wherein there may be provided with m types of regular polygonal plates 2 which correspond to the set number of splicing units, that is, each set of splicing units corresponds to a regular polygonal plate 2, herein, the regular polygonal plate 2 can be set as a regular triangular plate, a square plate, a regular pentagon plate, a regular hexagon plate, a regular octagonal plate, and a regular decagon plate, depending on the specific situation. In this way, the spliced basic shapes are various, which is conducive to realizing the diversity of splicing, and can improve the self-learning ability and hands-on operation ability of students; at the same time, the side length of the regular polygonal plate 2 is equal to the bottom length of the ath type of splicing plates 1, which can achieve the splicing between the sides. The area of the regular polygonal plate 2 can also produce an equal proportion of area change.

In some embodiments, the geometric splicing device further comprises a plurality of diamond plates having a side length equal to the bottom length of the ath type of splicing plates, wherein there may be provided with 2-6 types of diamond plates, and the apex angles of the diamond plates 1 are 120° (purple), 108° (orange), 60° (yellow), 45° (green), 36° (blue) and 30° (blue-violet), respectively. In this way, the spliced basic shapes are various, which is conducive to realizing the diversity of splicing, and can improve the self-learning ability and hands-on operation ability of students; at the same time, the side length of the diamond plates is equal to the bottom length of the ath type of splicing plates 1, which can achieve the splicing between the sides.

It can be understood that the splicing plate 1, the regular polygonal plate 2, and the diamond plate are all flat plate-like splicing blocks, and the thickness thereof is not considered, that is, the thickness of the splicing plate 1 and the regular polygonal plate 2 is not limited in the present application. The shape characteristics of the plate surface are only prioritized.

In some embodiments, the splicing plate 1 is made of paper, and one side of the splicing plates can be pasted to each other to form a double-sided pattern splicing work without a carrier. Since the paper splicing plate 1 is easy to be cut and spliced, it can be modified by teachers and students according to their own needs. During splicing, an adhesive is required to be coated on one side of the splicing plate 1, so that the splicing plate 1 can be pasted on the carrier, which is time-saving, labor-saving, convenient and quick; thus, the structure is simple, the cost is low, and it is convenient to splice and fix the splicing plate 1. The splicing stability of the splicing plate 1 is improved, which is conducive to splicing and storage.

In other embodiments, a magnetic structure is provided on the splicing plate 1. The splicing plate 1 is spliced on the corresponding carrier and can be fixed on the carrier 3 by a magnetic structure. The magnetic structure comprises a first magnetic member on the splicing plate 1 and a second magnetic member on the carrier 3. The corresponding carriers of the first magnetic member and the second magnetic members are attracted to each other. Thus, the splicing plate 1 and the carrier 3 can be mutually adsorbed to achieve splicing and fixing. In this way, the splicing plate 1 is fixed on the carrier 3 by magnetic attraction, and when the pattern needs to be changed, the splicing plate 1 can be removed, which is time-saving and labor-saving and can realize multiple splicing and fixing. It is convenient to adjust the positional relationship of the splicing plates 1 to realize the diversity of the splicing pattern.

In some embodiments, the positional relationship between the carrier 3 and the splicing plate 1 is as shown in FIG. 1, and the positional relationship between the carrier 3, the splicing plate 1 and the regular polygonal plate 2 is as shown in FIG. 2.

Further, the first magnetic member is provided as a magnet and is located inside the splicing plate 1, and the second magnetic member is provided as an iron layer. The iron layer is located on one side of the carrier 3. When the magnet approaches the iron layer of the carrier, the splicing plate 1 is forced to be adsorbed on the carrier 3, so that the operation is convenient, time-saving and labor-saving, improving the splicing stability of the splicing plate 1. It is conducive to splicing and storage. The splicing plate 1 can be repeatedly used in multiple teaching, extending the service life and increasing the practical value.

In order to facilitate distinguishing the splicing plates 1 of different sizes and shapes, one side of the splicing plates 1 in each set of splicing units is coated with a different color to facilitate distinguishing, wherein the color systems of the colors which different sets of splicing units are coated with are different. The color depth of the kth type of splicing plates 1 in the same set of splicing units is smaller than the color depth of the k−1th type of splicing plates 1. In this way, different sets are distinguished by different color systems, and the size of the splicing plate 1 in the same set is distinguished by the brightness of different hues. The color is rich and the contrast is sharp. The splicing plates can be classified according to different angles, and the interrelation is found between the splicing plates, which is conducive to guiding students to explore the inherent laws of geometric patterns so as to make knowledge and interest uniform. In other embodiment, only the splicing plates of the same type appear alone, and are not mixed with other sets. On this type of splicing plates, a plurality of hues of the same set of splicing plates will appear.

It should be noted that one side of the splicing plate 1 is coated with different colors. Here, one side of the splicing plate 1 may be coated with colors, the other side may be kept the basic color (white or black), or both sides of the splicing plate 1 may be coated with colors, and the colors on both sides are the same. In the process of splicing, the splicing can be performed on the front side of the splicing plate 1 or on the reverse side of the splicing plate 1. The manner of splicing on the front and back sides is conducive to improving the splicing diversity of the splicing plate 1 and improving the diversity of the splicing law of the splicing patterns, and is conducive to student analysis and research.

In this embodiment, there are provided with 6 sets of splicing units, and the apex angles of each set of splicing plates 1 are 120°, 108°, 90°, 60°, 45°, and 36°, respectively, which is conducive to improving the diversity of the splicing patterns. The isosceles triangle with an apex angle of 108° cannot be spliced into a regular polygon centered on the apex, and other isosceles triangles can be spliced into a regular polygon. For the isosceles triangle with an apex angle of 108° and 36°, the ratio of the lengths of the waist to the bottom is the golden ratio, which is conducive to students and teachers to explore and research the geometric laws of the patterns and enhancing the learning enthusiasm of students.

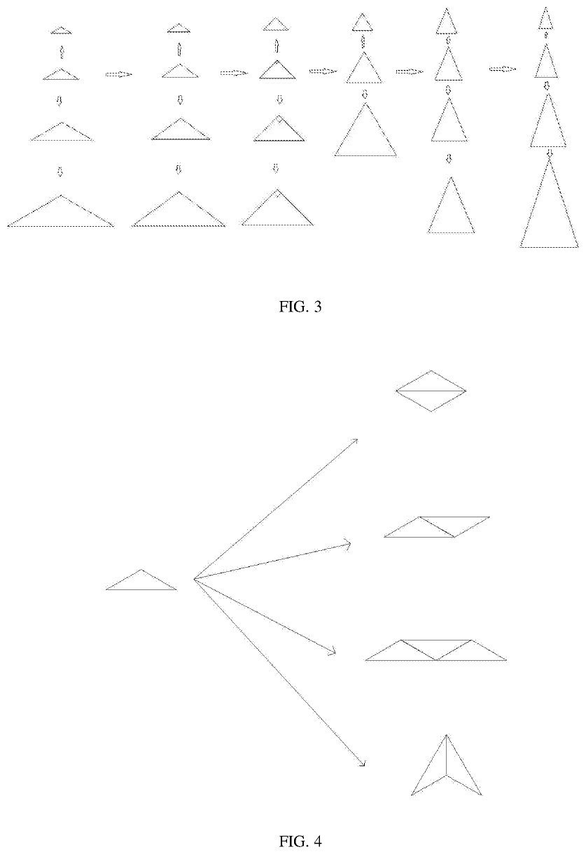

As shown in FIG. 3, the relationship of the side length and the size between each set of splicing units is shown, and the relationship of the side length and the size between the splicing plates 1 in the same set of splicing units is also shown. The bottom lengths of the second row of splicing plates 1 are equal, and the splicing plates 1 of each column are based on the second row of splicing. Each vertical column is divided into the same set, and a total of 6 columns are set, that is, 6 sets of splicing units, which are set from left to right in order:

the first set of splicing units, wherein there are provided with four types of splicing plates 1, and the apex angle of the splicing plates 1 is 120°;

the second set of splicing units, wherein there are provided with four types of splicing plates 1, and the apex angle of the splicing plates 1 is 108°;

the third set of splicing units, wherein there are provided with four types of splicing plates 1, and the apex angle of the splicing plates 1 is 90°;

the fourth set of splicing units, wherein there are provided with three types of splicing plates 1, and the apex angle of the splicing plates 1 is 60°;

the fifth set of splicing units, wherein there are provided with four types of splicing plates 1, and the apex angle of the splicing plates 1 is 45°;

the sixth set of splicing units, wherein there are provided with four types of splicing plates 1, and the apex angle of the splicing plates 1 is 36°.

Taking the first set of splicing units as an example, from top to bottom, there are the first type of splicing plates 1, the second type of splicing plates 1, the third type of splicing plates 1, and the fourth type of splicing plates 1, and the colors of the splicing plates 1 from top to bottom become lightened in order to distinguish the size of the splicing plates 1 in the same set.

It should be noted that there may also be provided with 2-6 types of regular polygonal plates 2, as shown in FIG. 2. The six regular polygonal plates 2 comprise a regular triangular plate, a square plate, a regular pentagon plate, a regular hexagon plate, a regular octagonal plate, and a regular decagon plate, respectively, and sequentially correspond to the colors of the 1-6th set of splicing units.

In the present embodiment, the bottom length of the ath splicing plate 1 is set to 45-55 mm, preferably 50 mm here. The size of the splicing plate 1 is conducive to the student to hold and the teacher to teach, and is suitable for splicing the patterns. Here, it is preferable that the bottom length of the second type of splicing plates 1 is set to 50 mm Since each set of the splicing plate 1 comprises 3-4 types of the splicing plate 1, the bottom length of the second type of splicing plates 1 is used as a reference, so that the difference in sizes of all the splicing plates 1 is not too large, and there is a certain splicing law, which is conducive to students to find the law of the pattern and geometry in the teaching of splicing and conducive to improving the quality of teaching.

In the process of splicing, a plurality of basic elements (the splicing plate 1 and the regular polygon plate 2) are spliced, arranged, and combined into unit modules, and then the unit modules are spliced, arranged, and combined into a combined pattern. The splicing manners are various, from being simple to being complex; from the combination of the positional changes between the basic elements to the combination of the unit modules; from the combination of the same type of splicing plates 1 of the same color system to the comprehensive application of different types of splicing plates 1 and regular polygon plates 2; moreover, the front and back sides of the splicing plates 1 can also be spliced to enhance the splicing diversity. The specific splicing manner can comprise the following types:

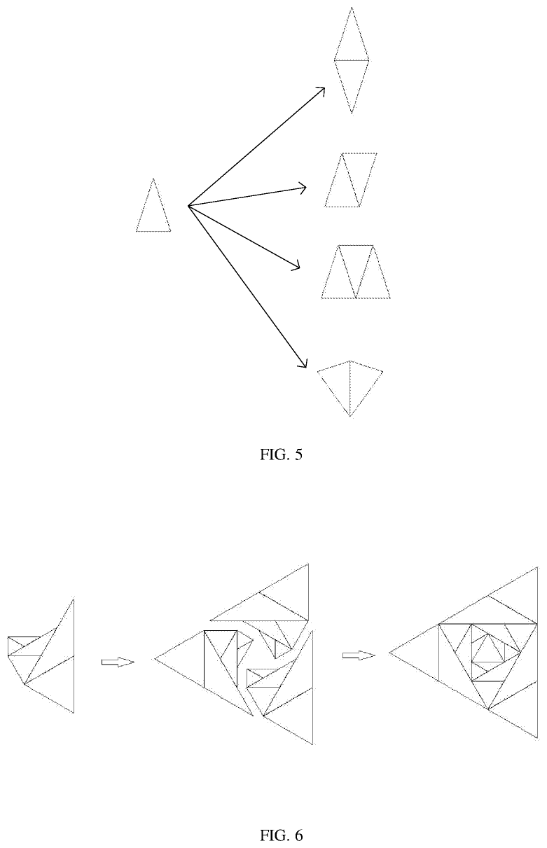

the equilateral sides of a plurality of equilateral splicing plates 1 are spliced, the parallelogram, the trapezoidal shape, and the kite shape may be formed when the waist is used as the splicing side, and the diamond shape may be formed when the bottom is used as the splicing side, as shown in FIGS. 4-5;

the equilateral sides of a plurality of splicing plates 1 which are similar triangles are spliced, such as the splicing between waists, the splicing between bottoms, the splicing between the waist and the bottom, and the splicing between the sides, as shown in FIGS. 8-10;

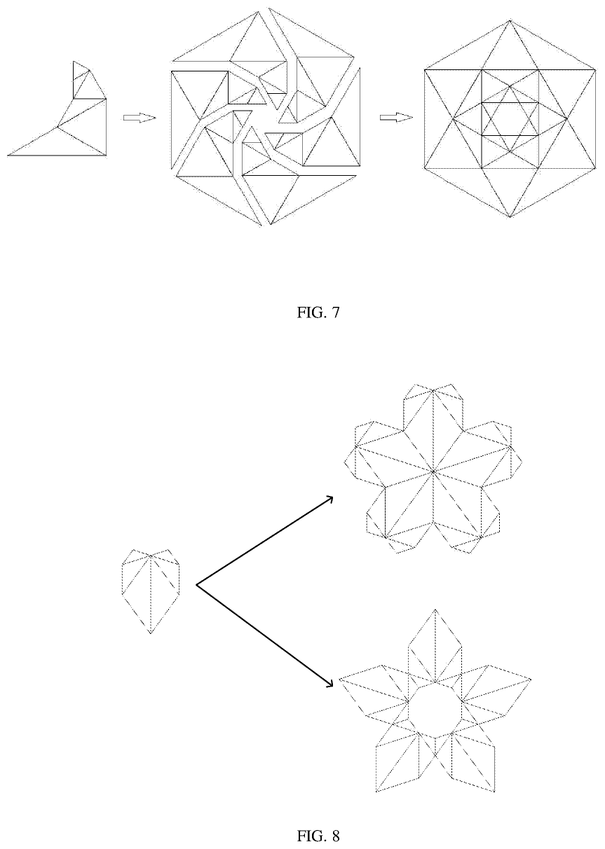

the equilateral sides of the splicing plates 1 in different sets are spliced, as shown in FIG. 7;

the equilateral sides of the splicing plates 1 are spliced, as shown in FIG. 6;

the spliced unit modules are arranged and combined, as shown in FIGS. 6-7.

The geometric splicing device can assist teaching so that students can learn plane pattern tessellation, pattern equality and similarity, translation and rotation, combination and cutting; the relationship between a triangle and a quadrilateral, the number relationship between patterns, the relationship between a regular polygon and a circle; the golden ratio, and other knowledge, and can be combined with real life to apply the pattern splicing works.

In summary, the geometric splicing device is used for assisting teaching, and can make up for the lack or deficiency of the links between “hands-on operation” and “self-exploration” when students are learning the knowledge of “pattern and geometry”. The geometric splicing device is designed for all primary and middle school students, and is designed based on the content of “pattern and geometry” in mathematics; a visual image is used as a carrier, using the varied patterns and beautiful colors to stimulate students' interest in geometric patterns. The self-exploration ability in hands-on operations is trained.

1. In the process of hands-on operation and splicing, the basic plane pattern is recognized, classification is performed from different angles, the changes in movement and position of the patterns are experienced, the nature and characteristics of different geometries are felt and experienced, and space concepts and geometric intuitiveness are gradually established. In the hands-on operation, students are made to understand specific and special geometric patterns, and then understand the abstract mathematical language and actively explore the inner laws;

2. The geometric splicing blocks of the product are highly operable, which is conducive to learning such as “hands-on experiment” and “self-exploration”; it conforms to the cognitive rules of students and allows students to obtain important “direct experience” in the cognitive process.

3. The used geometric blocks can produce an ever-changing pattern combination effect, which can exert the subjectivity and creativity of each person. Since the geometric splicing device can be a material that can be pasted or adsorbed, it is possible to not only complete the creative works designed by oneself, but also can be preserved.

The above is only a specific embodiment of the present invention, but the scope of protection of the present invention is not limited thereto, and any changes or substitutions conceivable to those skilled in the art within the technical scope disclosed by the present invention should be covered in the scope of protection of the present invention. Therefore, the scope of protection of the present invention should be subject to the scope of protection of the appended claims.

It is to be understood that the same or similar parts in the above embodiments may be referred to each other, and those not described in detail in some embodiments may refer to the same or similar contents in other embodiments.

While the embodiments of the present application have been shown and described above, it is understood that the above embodiments are illustrative and are not to be construed as limiting the scope of the present application. Those skilled in the art can make changes, modifications, substitutions and variations to the above embodiments within the scope of the present application.

What is claimed is:

1. A geometric pattern splicing device for assisting teaching, comprising: m sets of splicing units, wherein each set of splicing units contains n types of splicing plates (1), and the splicing plate (1) is made of a pasteable material or a magnetic structure so that the splicing plate (1) is capable of being pasted or adsorbed on a carrier; where m is a positive integer greater than or equal to 2, and n is a positive integer greater than or equal to 3;
the splicing plate is an isosceles triangle, the same set of splicing plates (1) are similar triangles, the apex angles of the splicing plates (1) are unequal in any two sets, and the bottom lengths of the ath type of splicing plates (1) are equal; in the same set of splicing units, when the apex angle of the splicing plate (1) is equal to 60°, the area of the kth type of splicing plates (1) is equal to three times the area of the k−1th type of splicing plates (1), and when the apex angle of the splicing plate (1) is greater than or less than 60°, the waist length of the kth type of splicing plates (1) is equal to the bottom length of the k−1th type of splicing plates (1), where a∈{1, 2, . . . , n}, k∈{2, 3, . . . , n}.

2. The geometric splicing device according to claim 1, further comprising a plurality of regular polygonal plates (2), each of which has a side length equal to the bottom length of the ath type of splicing plates (1).

3. The geometric splicing device according to claim 1, further comprising a plurality of diamond plates having a side length equal to the bottom length of the ath type of splicing plates (1).

4. The geometric splicing device according to claim 1, wherein the splicing plate (1) is made of paper, and the splicing plate (1) is fixed on the carrier by an adhesive applied on one side.

5. The geometric splicing device according to claim 1, further comprising a carrier (3) for carrying and splicing the splicing plate (1), wherein the splicing plate (1) is provided with a magnetic structure comprising a first magnetic member on the splicing plate (1) and a second magnetic member on the carrier (3), and the first magnetic member and the second magnetic members are attracted to each other.

6. The geometric splicing device according to claim 5, wherein the first magnetic member is provided as a magnet and is located inside the splicing plate (1), and the second magnetic member is an iron layer provided on the carrier (3).

7. The geometric splicing device according to claim 1, wherein one side of each set of splicing plates (1) is coated with a different color, and the color depth of the kth type of splicing plates (1) in the same set is smaller than the color depth of the k−1th type of splicing plates (1).

8. The geometric splicing device according to claim 7, wherein there are provided with 2-6 sets of splicing units, and the apex angles of each set of splicing plates (1) are 120°, 108°, 90°, 60°, 45°, and 36°, respectively.
